(19) United States
(12) Patent Application Publication
(10) Pub. No.: US 2026/0312764 A1
(43) Pub. Date: Oct. 8, 2026

(54) METHOD FOR INDICATING REFERENCE SIGNAL, COMMUNICATION APPARATUS, AND COMMUNICATION SYSTEM

(71) Applicant: HUAWEI TECHNOLOGIES CO., LTD., Shenzhen (CN)

(72) Inventors: Junhui Gao, Shanghai (CN); Xiaohan Wang, Shanghai (CN); Huangping Jin, Ottawa (CA)

(73) Assignee: HUAWEI TECHNOLOGIES CO., LTD., Shenzhen (CN)

(21) Appl. No.: 19/539,601

(22) Filed: Feb. 13, 2026

Related U.S. Application Data
(63) Continuation of application No. PCT/CN2024/110443, filed on Aug. 7, 2024.

(30) Foreign Application Priority Data
Aug. 16, 2023 (CN) 202311036741.0

(51) Int. Cl. H04L 5/00

(52) U.S. Cl. CPC H04L 5/0051; H04L 5/0057

(57) ABSTRACT

A method for indicating a reference signal, a communication apparatus, and a communication system. In the method, a terminal device receives first indication information, where the first indication information includes port information of a first DMRS; and the terminal device determines CSI-RS port information of the terminal device based on the first indication information. Therefore, a network device may not need to send, to the terminal device, separate indication information indicating a CSI-RS port of the terminal device. Therefore, signaling overheads are reduced, to help save air interface resources.

### CROSS-REFERENCE TO RELATED APPLICATIONS

This application is a continuation of International Application No. PCT/CN2024/110443, filed on Aug. 7, 2024, which claims priority to Chinese Patent Application No. 202311036741.0, filed on Aug. 16, 2023. The disclosures of the aforementioned applications are hereby incorporated by reference in their entireties.

### TECHNICAL FIELD

The embodiments relate to the field of communication technologies, for example, to a method for indicating a reference signal, a communication apparatus, and a communication system.

### BACKGROUND

Compared with a conventional mobile communication system, a 5th generation (5G) mobile communication system and a future wireless communication system are dedicated to supporting higher system performance, and support a plurality of service types, a wide deployment scenario, and a wider spectrum range. This causes more air interface signaling between a terminal device and a network device, resulting in straining air interface resources.

How to reduce overheads of air interface signaling, for example, reduce overheads of signaling indicating a reference signal, may be resolved.

### SUMMARY

Embodiments provide a method for indicating a reference signal, a communication apparatus, and a communication system, to reduce overheads of air interface signaling.

According to a first aspect, an embodiment provides a method for indicating a reference signal. The method may be performed by a terminal device or a module (for example, a chip) in the terminal device. The method includes: receiving first indication information, where the first indication information includes port information of a first demodulation reference signal (DMRS); and determining port information of a first channel state information reference signal (CSI-RS) based on the first indication information.

In the foregoing solution, there is a mapping relationship or a correspondence between the first indication information and CSI-RS port information of the terminal device, and the terminal device may determine the CSI-RS port information of the terminal device based on the first indication information. Therefore, a network device may not need to send, to the terminal device, separate indication information indicating a port of a CSI-RS of the terminal device, but determines the port information of the first CSI-RS by using the first indication information that originally may be sent and that indicates a port of the first DMRS. In other words, the first indication information and the port information of the first CSI-RS originally may be sent. However, in the solution, only the first indication information may be sent. Therefore, signaling overheads are reduced, to help save air interface resources. In addition, in the solution, the terminal device determines the port information of the first CSI-RS based on the first indication information, instead of indicating, by the network device, the port information of the first CSI-RS by using air interface signaling, so that the port information of the first CSI-RS can be quickly determined. This is because time for which the terminal device determines the port information of the first CSI-RS based on the first indication information is shorter than time for receiving the air interface signaling and obtaining the port information of the first CSI-RS by parsing the air interface signaling.

In a possible embodiment, the first indication information includes a port index of the first DMRS, and the port information of the first CSI-RS includes a port index of the first CSI-RS.

In a possible embodiment, the port index of the first CSI-RS is the same as the port index of the first DMRS.

In a possible embodiment, the determining the port information of the first CSI-RS based on the first indication information includes: determining the port information of the first CSI-RS corresponding to the first indication information based on the first indication information and a first mapping relationship predefined in a protocol, where the first mapping relationship includes a mapping relationship between DMRS port information and CSI-RS port information, the DMRS port information includes the port information of the first DMRS, and the CSI-RS port information includes the port information of the first CSI-RS.

In the foregoing solution, the terminal device may determine, based on the first mapping relationship predefined in the protocol, the port information of the first CSI-RS corresponding to the first indication information, so that the port information of the first CSI-RS can be accurately and quickly determined.

In a possible embodiment, the method further includes: receiving second indication information, where the second indication information includes a second mapping relationship between the first indication information and the port information of the first CSI-RS; and the determining the port information of the first CSI-RS based on the first indication information includes: determining the port information of the first CSI-RS based on the first indication information and the second mapping relationship.

In the foregoing solution, the network device indicates, to the terminal device, the second mapping relationship between the first indication information and the port information of the first CSI-RS, to help the terminal device accurately determine the port information of the first CSI-RS.

In a possible embodiment, the method further includes: receiving a second CSI-RS; and determining the first CSI-RS in the second CSI-RS based on the first indication information.

In a possible embodiment, the method further includes: receiving a first message, where the first message includes configuration information of a third CSI-RS, and the second CSI-RS is a part of the third CSI-RS.

In the foregoing solution, a CSI-RS configuration, for example, the configuration information of the third CSI-RS, is configured for the terminal device by using the first message. A port number of the second CSI-RS sent by the network device may be less than a port number of the configured third CSI-RS, so that the CSI-RS can be flexibly sent. In addition, because the CSI-RS may not need to be sent on all configured ports of the CSI-RS (for example, ports of the third CSI-RS) each time, but the CSI-RS is sent according to a requirement (in other words, the second CSI-RS is sent), overheads can be reduced.

In a possible embodiment, the method further includes: receiving a first message, where the first message includes a plurality of pieces of configuration information; and the receiving the second CSI-RS includes: receiving the second CSI-RS based on configuration information of a fourth CSI-RS in the plurality of pieces of configuration information, where the second CSI-RS is a part of the fourth CSI-RS.

In the foregoing solution, a plurality of CSI-RS configurations are configured for the terminal device by using the first message. During sending, one CSI-RS configuration may be selected in the plurality of CSI-RS configurations to send the CSI-RS, so that the CSI-RS can be flexibly sent. In addition, because the CSI-RS may not need to be sent on all configured ports of the CSI-RS (for example, ports of the fourth CSI-RS) each time, but the CSI-RS is sent according to a requirement (in other words, the second CSI-RS is sent), overheads can be reduced.

In a possible embodiment, the method further includes: receiving third indication information, where the third indication information includes the configuration information of the fourth CSI-RS in the plurality of pieces of CSI-RS configuration information.

In the foregoing solution, the network device indicates the selected configuration information of the fourth CSI-RS to the terminal device, so that a CSI-RS configuration can be accurately determined.

In a possible embodiment, the method further includes: determining the configuration information of the fourth CSI-RS based on DMRS configuration information, where the configuration information of the fourth CSI-RS is associated with the DMRS configuration information, and the DMRS configuration information includes at least one of the following information: a DMRS type, a maximum number of DMRS symbols, a number of front-loaded DMRS symbols, or a number of DMRS CDM groups.

In the foregoing solution, the terminal device determines the configuration information of the fourth CSI-RS in the plurality of pieces of CSI-RS configuration information based on the DMRS configuration information, so that a CSI-RS configuration can be accurately determined. In addition, no additional indication information is needed, thereby reducing signaling overheads.

In a possible embodiment, the determining the configuration information of the fourth CSI-RS based on the DMRS configuration information includes: determining a maximum number of DMRS ports based on the DMRS configuration information; and determining the configuration information of the fourth CSI-RS based on the maximum number of DMRS ports, where a port number of the fourth CSI-RS is a smallest value in a CSI-RS port number set, each CSI-RS port number in the CSI-RS port number set is included in numbers of CSI-RS ports indicated by all of the plurality of pieces of CSI-RS configuration information, and each CSI-RS port number in the CSI-RS port number set is greater than or equal to the maximum number of DMRS ports.

In a possible embodiment, the maximum number of DMRS symbols is equal to 1, and the maximum number of DMRS ports is equal to a product of a and the number of DMRS CDM groups; or the maximum number of DMRS symbols is equal to 2, and the maximum number of DMRS ports is equal to a product of a, the number of DMRS CDM groups, and the number of front-loaded DMRS symbols, where a is related to the DMRS type.

In a possible embodiment, the DMRS type is a type 1 or a type 2, and a is equal to 2; or the DMRS type is an enhanced type 1 or an enhanced type 2, and a is equal to 4.

In a possible embodiment, the method further includes: receiving fourth indication information, where the fourth indication information includes the DMRS configuration information, or the first indication information and the fourth indication information indicate the DMRS configuration information.

In a possible embodiment, the plurality of pieces of CSI-RS configuration information further include configuration information of a fifth CSI-RS, and a port number of the fifth CSI-RS is different from the port number of the fourth CSI-RS.

In a possible embodiment, the method further includes: determining uplink precoding based on the port information of the first CSI-RS.

According to a second aspect, an embodiment provides a method for indicating a reference signal. The method may be performed by a terminal device or a module (for example, a chip) in the terminal device. The method includes: receiving a first message, where the first message includes configuration information of a third CSI-RS; and receiving a second CSI-RS, where the second CSI-RS is a part of the third CSI-RS.

In the foregoing solution, a CSI-RS configuration, for example, the configuration information of the third CSI-RS, is configured for the terminal device by using the first message. A port number of the second CSI-RS sent by a network device may be less than a port number of the configured third CSI-RS, so that the CSI-RS can be flexibly sent. In addition, because the CSI-RS may not need to be sent on all configured ports of the CSI-RS (for example, ports of the third CSI-RS) each time, but the CSI-RS is sent according to a requirement (in other words, the second CSI-RS is sent), overheads can be reduced.

According to a third aspect, an embodiment provides a method for indicating a reference signal. The method may be performed by a terminal device or a module (for example, a chip) in the terminal device. The method includes: receiving a first message, where the first message includes a plurality of pieces of CSI-RS configuration information; and receiving a second CSI-RS based on configuration information of a fourth CSI-RS in the plurality of pieces of CSI-RS configuration information, where the second CSI-RS is a part of the fourth CSI-RS.

In the foregoing solution, a plurality of CSI-RS configurations are configured for the terminal device by using the first message. During sending, one CSI-RS configuration may be selected in the plurality of CSI-RS configurations to send the CSI-RS, so that the CSI-RS can be flexibly sent. In addition, because the CSI-RS may not need to be sent on all configured ports of the CSI-RS (for example, ports of the fourth CSI-RS) each time, but the CSI-RS is sent according to a requirement (in other words, the second CSI-RS is sent), overheads can be reduced.

In a possible embodiment, the method further includes: receiving third indication information, where the third indication information includes the configuration information of the fourth CSI-RS in the plurality of pieces of CSI-RS configuration information.

In a possible embodiment, fourth indication information is received, where the fourth indication information includes DMRS configuration information, or the fourth indication information and the first indication information indicate the DMRS configuration information; the DMRS configuration information is associated with the configuration information of the fourth CSI-RS; and the DMRS configuration information includes at least one of the following information: a DMRS type, a maximum number of DMRS symbols, a number of front-loaded DMRS symbols, or a number of DMRS CDM groups.

According to a fourth aspect, an embodiment provides a method for indicating a reference signal. The method may be performed by a network device or a module (for example, a chip) in the network device. The method includes: determining first indication information, where the first indication information includes port information of a first DMRS, and the port information of the first DMRS is for determining port information of a first CSI-RS; and sending the first indication information.

In a possible embodiment, the first indication information includes a port index of the first DMRS, and the port information of the first CSI-RS includes a port index of the first CSI-RS.

In a possible embodiment, the port index of the first CSI-RS is the same as the port index of the first DMRS.

In a possible embodiment, a first mapping relationship between DMRS port information and CSI-RS port information is predefined in a protocol, the DMRS port information includes the port information of the first DMRS, and the CSI-RS port information includes the port information of the first CSI-RS.

In the foregoing solution, the terminal device may determine, based on the first mapping relationship predefined in the protocol, the port information of the first CSI-RS corresponding to the first indication information, so that the port information of the first CSI-RS can be accurately and quickly determined.

In a possible embodiment, the method further includes: sending second indication information, where the second indication information includes a second mapping relationship between the first indication information and the port information of the first CSI-RS.

In the foregoing solution, the network device indicates, to the terminal device, the second mapping relationship between the first indication information and the port information of the first CSI-RS, to help the terminal device accurately determine the port information of the first CSI-RS.

In a possible embodiment, the method further includes: sending a first message, where the first message includes configuration information of a third CSI-RS; and sending a second CSI-RS, where the second CSI-RS is a part of the third CSI-RS, and the second CSI-RS includes the first CSI-RS.

In a possible embodiment, the method further includes: sending a first message, where the first message includes a plurality of pieces of CSI-RS configuration information; sending third indication information, where the third indication information includes configuration information of a fourth CSI-RS in the plurality of pieces of CSI-RS configuration information; and sending a second CSI-RS, where the second CSI-RS is a part of the fourth CSI-RS.

In a possible embodiment, the method further includes: sending a first message, where the first message includes a plurality of pieces of CSI-RS configuration information; sending fourth indication information, where the fourth indication information includes DMRS configuration information, or the first indication information and the fourth indication information indicate the DMRS configuration information; the DMRS configuration information is associated with configuration information of a fourth CSI-RS in the plurality of pieces of CSI-RS configuration information; and the DMRS configuration information includes at least one of the following information: a DMRS type, a maximum number of DMRS symbols, a number of front-loaded DMRS symbols, or a number of DMRS CDM groups; and sending a second CSI-RS, where the second CSI-RS is a part of the fourth CSI-RS.

In a possible embodiment, a port number of the fourth CSI-RS is a smallest value in a CSI-RS port number set, each CSI-RS port number in the CSI-RS port number set is included in numbers of CSI-RS ports indicated by all of the plurality of pieces of CSI-RS configuration information, each CSI-RS port number in the CSI-RS port number set is greater than or equal to a maximum number of DMRS ports, and the maximum number of DMRS ports is associated with the DMRS configuration information.

In a possible embodiment, the maximum number of DMRS symbols is equal to 1, and the maximum number of DMRS ports is equal to a product of a and the number of DMRS CDM groups; or the maximum number of DMRS symbols is equal to 2, and the maximum number of DMRS ports is equal to a product of a, the number of DMRS CDM groups, and the number of front-loaded DMRS symbols, where a is related to the DMRS type.

In a possible embodiment, the DMRS type is a type 1 or a type 2, and a is equal to 2; or the DMRS type is an enhanced type 1 or an enhanced type 2, and a is equal to 4.

In a possible embodiment, the plurality of pieces of CSI-RS configuration information further include configuration information of a fifth CSI-RS, and a port number of the fifth CSI-RS is different from the port number of the fourth CSI-RS.

According to a fifth aspect, an embodiment provides a method for indicating a reference signal. The method may be performed by a network device or a module (for example, a chip) in the network device. The method includes: sending a first message, where the first message includes configuration information of a third CSI-RS; and sending a second CSI-RS, where the second CSI-RS is a part of the third CSI-RS.

According to a sixth aspect, an embodiment provides a method for indicating a reference signal. The method may be performed by a network device or a module (for example, a chip) in the network device. The method includes: sending a first message, where the first message includes a plurality of pieces of CSI-RS configuration information; sending third indication information, where the third indication information includes configuration information of a fourth CSI-RS in the plurality of pieces of CSI-RS configuration information; and sending a second CSI-RS, where the second CSI-RS is a part of the fourth CSI-RS.

According to a seventh aspect, an embodiment provides a method for indicating a reference signal. The method may be performed by a network device or a module (for example, a chip) in the network device. The method includes: sending a first message, where the first message includes a plurality of pieces of CSI-RS configuration information; sending fourth indication information, where the fourth indication information includes DMRS configuration information, the DMRS configuration information is associated with configuration information of a fourth CSI-RS in the plurality of pieces of CSI-RS configuration information, and the DMRS configuration information includes at least one of the following information: a DMRS type, a maximum number of DMRS symbols, a number of front-loaded DMRS symbols, or a number of DMRS CDM groups; and sending a second CSI-RS, where the second CSI-RS is a part of the fourth CSI-RS.

For effects of the network device, refer at least to effects of a terminal device side. Details are not described again.

According to an eighth aspect, an embodiment provides a communication apparatus. The apparatus may be a terminal device, or may be a module (for example, a chip) in the terminal device. The apparatus has a function of implementing the method in any one of the foregoing embodiments of the first aspect to the third aspect. The function may be implemented by hardware, or may be implemented by hardware executing corresponding software. The hardware or the software includes one or more modules corresponding to the foregoing function.

According to a ninth aspect, an embodiment provides a communication apparatus. The apparatus may be a network device, or may be a module (for example, a chip) in the network device. The apparatus has a function of implementing the method in any one of the foregoing embodiments of the fourth aspect to the seventh aspect. The function may be implemented by hardware, or may be implemented by hardware executing corresponding software. The hardware or the software includes one or more modules corresponding to the foregoing function.

According to a tenth aspect, an embodiment provides a communication apparatus, including units or means configured to perform steps or operations in any one of the foregoing embodiments of the first aspect to the seventh aspect.

According to an eleventh aspect, an embodiment provides a communication apparatus, including a processor and an interface circuit. The processor is configured to communicate with another apparatus through the interface circuit, and perform any one of the foregoing embodiments of the first aspect to the seventh aspect. There are one or more processors.

According to a twelfth aspect, an embodiment provides a communication apparatus, including a processor. The processor is configured to invoke a program to perform any one of the foregoing embodiments of the first aspect to the seventh aspect. In addition, there may be one or more processors.

Optionally, the communication apparatus may further include a memory. The memory is coupled to the processor. The memory may be located inside the apparatus, or may be located outside the apparatus.

According to a thirteenth aspect, an embodiment provides a communication apparatus, including a processor. When the apparatus runs, the processor executes computer instructions, to cause the apparatus to perform any one of the foregoing embodiments of the first aspect to the seventh aspect.

Optionally, the communication apparatus may further include a memory, and the memory is configured to store the computer instructions.

According to a fourteenth aspect, an embodiment further provides a computer program product. The computer program product includes a computer program or instructions. The computer program or instructions, when executed by a communication apparatus, cause any one of the foregoing embodiments of the first aspect to the seventh aspect to be performed.

According to a fifteenth aspect, an embodiment further provides a non-transitory computer-readable storage medium. The non-transitory computer-readable storage medium stores instructions. The instructions, when run on a communication apparatus, cause any one of the foregoing embodiments of the first aspect to the seventh aspect to be performed.

According to a sixteenth aspect, an embodiment further provides a chip system, including a processor, configured to perform any one of the foregoing embodiments of the first aspect to the sixth aspect.

According to a seventeenth aspect, an embodiment further provides a communication system, including a terminal device configured to perform any one of the foregoing embodiments of the first aspect, and a network device configured to perform any one of the foregoing embodiments of the fourth aspect.

According to an eighteenth aspect, an embodiment further provides a communication system, including a terminal device configured to perform any one of the foregoing embodiments of the second aspect, and a network device configured to perform any one of the foregoing embodiments of the fifth aspect.

According to a nineteenth aspect, an embodiment further provides a communication system, including a terminal device configured to implement the method in the third aspect, and a network device configured to implement any one of the foregoing embodiments of the sixth aspect or the seventh aspect.

### BRIEF DESCRIPTION OF DRAWINGS

FIG. 1(a) is a diagram of an architecture of a communication system to which an embodiment is applicable;

FIG. 1(b) is a diagram of a network device;

FIG. 2 is a schematic flowchart of a method for indicating a reference signal according to an embodiment;

FIG. 3 is a schematic flowchart of a method for sending a CSI-RS according to an embodiment;

FIG. 4 is a diagram of a structure of a communication apparatus according to an embodiment; and

FIG. 5 is a diagram of a structure of a communication apparatus according to an embodiment.

### DETAILED DESCRIPTION OF EMBODIMENTS

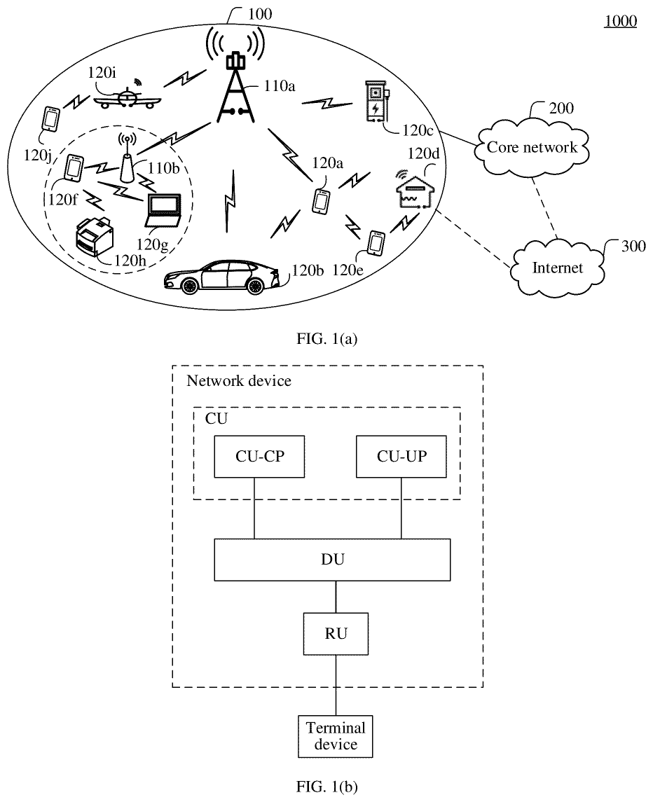

FIG. 1(a) is a diagram of an architecture of a communication system to which an embodiment is applicable. A communication system 1000 shown in FIG. 1(a) includes a radio access network 100 and a core network 200. Optionally, the communication system 1000 further includes an Internet 300. The radio access network 100 may include at least one network device (for example, 110a and 110b in FIG. 1(a)), and may further include at least one terminal device (for example, 120a to 120j in FIG. 1(a)). The terminal device is connected to the network device in a wireless manner, and the network device is connected to the core network in a wireless or wired manner. A core network device and the network device may be different physical devices that are independent of each other, functions of the core network device and logical functions of the network device may be integrated into a same physical device, or a part of functions of the core network device and a part of functions of the network device may be integrated into one physical device. Terminal devices may be connected to each other and network devices may be connected to each other in a wired or wireless manner. FIG. 1(a) is only a diagram. The communication system may further include other network devices, for example, a wireless relay device and a wireless backhaul device, which are not shown in FIG. 1(a).

The network device is an access device used by the terminal device to access the communication system in a wired or wireless manner. The network device may be a base station, an evolved nodeB (eNodeB), a transmission and reception point (TRP), a next generation nodeB (gNB) in a 5th generation (5G) mobile communication system, a next generation base station in a 6th generation (6G) mobile communication system, a base station in a future mobile communication system, an access node in a wireless fidelity (Wi-Fi) system, or the like; or may be a module or a unit that completes a part of functions of the base station, for example, may be a central unit (CU), or may be a distributed unit (DU). The CU herein completes functions of a radio resource control protocol and a packet data convergence protocol (PDCP) of the base station, and may further complete functions of a service data adaptation protocol (SDAP). The DU completes functions of a radio link control layer and a medium access control (MAC) layer of the base station, and may further complete a function of a part or all of physical layers. For descriptions of the foregoing protocol layers, refer to specifications related to the 3rd generation partnership project (3GPP). The network device may be a macro base station (for example, 110a in FIG. 1(a)), may be a micro base station or an indoor base station (for example, 110b in FIG. 1(a)), or may be a relay node, a donor node, or the like. A technology and a device form that are used by the network device are not limited.

The terminal device is a device having a wireless transceiver function, and may send a signal to the network device, or receive a signal from the network device. The terminal device includes but is not limited to a terminal apparatus, a terminal, user equipment (UE), a mobile station, a mobile terminal, and the like. The terminal device may be widely used in various scenarios, for example, device-to-device (D2D), vehicle-to-everything (V2X) communication, machine type communication (MTC), an Internet of Things (IoT), virtual reality, augmented reality, industrial control, autonomous driving, telemedicine, a smart grid, smart furniture, a smart office, a smart wearable, smart transportation, and a smart city. The terminal device may be a mobile phone, a tablet computer, a computer having a wireless transceiver function, a wearable device, a vehicle, an airplane, a ship, a robot, a robot arm, a smart home device, or the like. A technology and a device form that are used by the terminal device are not limited.

The network device and the terminal device may be at fixed positions, or may be movable. The network device and the terminal device may be deployed on land, including indoor devices, outdoor devices, handheld devices, or vehicle-mounted devices; may be deployed on water; or may be deployed on an airplane, a balloon, and a man-made satellite. Application scenarios of the network device and the terminal device are not limited.

Roles of the network device and the terminal device may be relative. For example, a helicopter or an unmanned aerial vehicle 120i in FIG. 1(a) may be configured as a mobile network device. For the terminal device 120j that accesses the radio access network 100 through 120i, the terminal device 120i is a network device. However, for the network device 110a, 120i is a terminal device, for example, 110a and 120i communicate with each other by using a radio air interface protocol. In another embodiment, 110a and 120i may alternatively communicate with each other by using an interface protocol between the network devices. In this case, compared with 110a, 120i is also a network device. Therefore, both the network device and the terminal device may be collectively referred to as communication apparatuses. 110a and 110b in FIG. 1(a) may be referred to as communication apparatuses having a function of the network device, and 120a to 120j in FIG. 1(a) may be referred to as communication apparatuses having a function of the terminal device.

Communication may be performed between the network device and the terminal device, between network devices, or between terminal devices by using a licensed spectrum, an unlicensed spectrum, or both a licensed spectrum and an unlicensed spectrum; or may be performed by using a spectrum below 6 gigahertz (GHz), a spectrum above 6 GHz, or both a spectrum below 6 GHz and a spectrum above 6 GHz. A spectrum resource for wireless communication is not limited.

In this embodiment, the function of the network device may alternatively be performed by a module (for example, a chip) in the network device, or may be performed by a control subsystem having the function of the network device. The control subsystem having the function of the network device may be a control center in the foregoing application scenarios such as the smart grid, the industrial control, the smart transportation, and the smart city. The function of the terminal device may alternatively be performed by a module (for example, a chip or a modem) in the terminal device, or may be performed by an apparatus having the function of the terminal device.

In the embodiments, the network device sends a downlink signal or downlink information to the terminal device, where the downlink information is carried on a downlink channel. The terminal device sends an uplink signal or uplink information to the network device, where the uplink information is carried on an uplink channel. To communicate with the network device, the terminal device may establish a wireless connection to a cell controlled by the network device. The cell that establishes the wireless connection to the terminal device is referred to as a serving cell of the terminal device.

FIG. 1(b) is a diagram of a network device. As shown in FIG. 1(b), the network device includes one CU, one or more DUs, and one or more radio units (RUs). For clarity, FIG. 1(b) shows only one CU, one DU, and one RU. The CU is configured to connect to a core network and the one or more DUs. Optionally, the CU may have a part of functions of the core network. The CU may include a CU-control plane (CP) and a CU-user plane (UP).

The CU and the DU may be configured based on a function of a protocol layer of a wireless network implemented by the CU and the DU. For example, the CU is configured to implement functions of a PDCP layer and a protocol layer above the PDCP layer (for example, a radio resource control (RRC) layer and/or an SDAP layer), and the DU is configured to implement a function of a protocol layer below the PDCP layer (for example, a radio link control (RLC) layer, a MAC layer, and/or a physical (PHY) layer). For another example, the CU is configured to implement a function of a protocol layer above a PDCP layer (for example, an RRC layer and/or an SDAP layer), and the DU is configured to implement functions of the PDCP layer and a protocol layer below the PDCP layer (for example, an RLC layer, a MAC layer, and/or a PHY layer).

The foregoing configurations of the CU and the DU are examples. Alternatively, functions of the CU and the DU may be configured as needed. For example, the CU or the DU may be configured to have functions of more protocol layers, or the CU or the DU may be configured to have a part of processing functions of protocol layers. For example, some functions of the RLC layer and a function of a protocol layer above the RLC layer are set on the CU, and remaining functions of the RLC layer and a function of a protocol layer below the RLC layer are set on the DU. For another example, division into functions of the CU or the DU may be performed based on service types or other system requirements. For example, division may be performed based on a delay. Functions whose processing time may meet a requirement for a small delay are set on the DU, and functions whose processing time may not need to meet the requirement for the delay are set on the CU.

The DU and the RU may work together to implement a function of the PHY layer. One DU may be connected to one or more RUs. Functions of the DU and the RU may be configured in a plurality of manners based on an embodiment. For example, the DU is configured to implement a baseband function, and the RU is configured to implement an intermediate radio frequency function. For another example, the DU is configured to implement a higher-layer function of the PHY layer, and the RU is configured to implement a lower-layer function of the PHY layer or implement the lower-layer function and a radio frequency function. The higher-layer function of the physical layer may include some functions of the physical layer, and the part of the function are closer to the MAC layer. The lower-layer function of the physical layer may include some other functions of the physical layer, and the some other functions are closer to an intermediate radio frequency side.

FIG. 2 is a schematic flowchart of a method for indicating a reference signal according to an embodiment. The method is performed by a network device or a module (for example, a chip) in the network device, and a terminal device or a module (for example, a chip) in the terminal device. The following provides descriptions by using an example in which the terminal device and the network device perform the method. The method includes the following steps or operations.

Step or operation 201: the network device determines first indication information.

The first indication information includes port information of a first demodulation reference signal (DMRS). The first indication information may also be referred to as the port information of the first DMRS. The first DMRS is a DMRS related to one terminal device, and the first DMRS includes one or more DMRSs corresponding to one or more DMRS ports.

The port information of the first DMRS may include a port index, a port identifier (ID), or another information that can indicate a port, for example, a number of front-loaded DMRS symbols or a number of DMRS code division multiplexing (CDM) groups.

For example, the port information of the first DMRS may be port information of a DMRS on a physical uplink shared channel (PUSCH).

Step or operation 202: the network device sends the first indication information to the terminal device. Correspondingly, the terminal device receives the first indication information.

For example, the first indication information is carried in downlink control information (DCI).

Step or operation 203: the terminal device determines port information of a first CSI-RS based on the first indication information.

That the terminal device determines the port information of the first CSI-RS based on the first indication information may alternatively be understood as that the terminal device determines the port information of the first channel state information reference signal (CSI-RS) based on the port information of the first DMRS. The first CSI-RS includes one or more CSI-RSs corresponding to one or more CSI-RS ports. The port information of the first CSI-RS may include a port index, a port identifier (ID), or another information that can indicate a port, for example, a type of CDM group.

In the foregoing solution, there is a mapping relationship or a correspondence between the first indication information and CSI-RS port information of the terminal device, and the terminal device may determine the CSI-RS port information of the terminal device based on the first indication information. Therefore, the network device may not need to send, to the terminal device, separate indication information indicating a port of a CSI-RS of the terminal device, but determines the port information of the first CSI-RS by using the first indication information that originally may be sent and that indicates a port of the first DMRS. In other words, the first indication information and the port information of the first CSI-RS originally may be sent. However, in the solution, only the first indication information may be sent. Therefore, signaling overheads are reduced, to help save air interface resources. In addition, in the solution, the terminal device determines the port information of the first CSI-RS based on the first indication information, instead of indicating, by the network device, the port information of the first CSI-RS by using air interface signaling, so that the port information of the first CSI-RS can be quickly determined. This is because time for which the terminal device determines the port information of the first CSI-RS based on the first indication information is shorter than time for receiving the air interface signaling and obtaining the port information of the first CSI-RS by parsing the air interface signaling.

For example, the first indication information includes a DMRS port index 1, a DMRS port index 2, and a DMRS port index 3, and the terminal device determines, based on the first indication information, that CSI-RS port indexes of the terminal device include a CSI-RS port index 1, a CSI-RS port index 2, and a CSI-RS port index 3. The CSI-RS port index 1 corresponds to the DMRS port index 1, the CSI-RS port index 2 corresponds to the DMRS port index 2, and the CSI-RS port index 3 corresponds to the DMRS port index 3.

In an embodiment, a first mapping relationship (which may also be referred to as a first correspondence) between DMRS port information of the terminal device and CSI-RS port information of the terminal device is predefined in a protocol. For example, a first mapping relationship between a DMRS port index and a CSI-RS port index is predefined in the protocol. The first mapping relationship may be a function relationship, for example, a hash function or a linear function. The DMRS port index may be the same as or different from the corresponding CSI-RS port index. For example, DMRS port indexes of the terminal device include 1001, 1002, and 1003, CSI-RS port indexes of the terminal device include 3001, 3002, and 3003, the DMRS port index 1001 of the terminal device corresponds to the CSI-RS port index 3001 of the terminal device, the DMRS port index 1002 of the terminal device corresponds to the CSI-RS port index 3002 of the terminal device, and the DMRS port index 1003 of the terminal device corresponds to the CSI-RS port index 3003 of the terminal device. For another example, DMRS port indexes of the terminal device include 1001, 1002, and 1003, CSI-RS port indexes of the terminal device include 1001, 1002, and 1003, the DMRS port index 1001 of the terminal device corresponds to the CSI-RS port index 1001 of the terminal device, the DMRS port index 1002 of the terminal device corresponds to the CSI-RS port index 1002 of the terminal device, and the DMRS port index 1003 of the terminal device corresponds to the CSI-RS port index 1003 of the terminal device.

Correspondingly, step or operation 203 may be: the terminal device determines, based on the first indication information, the port information of the first CSI-RS corresponding to the first indication information from the first mapping relationship predefined in the protocol.

In still another embodiment, before step or operation 201, the network device further sends second indication information to the terminal device. The second indication information includes a second mapping relationship between the first indication information and the port information of the first CSI-RS. Correspondingly, step or operation 203 may be: the terminal device determines the port information of the first CSI-RS based on the first indication information and the second mapping relationship. An embodiment of the second mapping relationship is similar to the foregoing embodiment of the first mapping relationship predefined in the protocol. Details are not described again.

Further, after determining the port information of the first CSI-RS, the terminal device may determine, based on the port information of the first CSI-RS, the first CSI-RS that is in a received second CSI-RS and that is related to the terminal device. In this case, as described in step or operation 302 below, the network device sends the second CSI-RS to the terminal device. The second CSI-RS includes a plurality of CSI-RSs that are sent by the network device and that correspond to different terminal devices. The second CSI-RS includes a plurality of CSI-RSs corresponding to a plurality of CSI-RS ports. For example, the second CSI-RS includes a CSI-RS 1 to a CSI-RS 6. The CSI-RS 1 and the CSI-RS 2 correspond to a terminal device 1, the CSI-RS 3 and the CSI-RS 4 correspond to a terminal device 2, and the CSI-RS 5 and the CSI-RS 6 correspond to a terminal device 3. The network device sends the CSI-RS 1 to the CSI-RS 6, and the terminal device 1 to the terminal device 3 each may receive the CSI-RS 1 to the CSI-RS 6. The terminal device 1 determines, based on port information of the CSI-RS 1 and the CSI-RS 2, the CSI-RS 1 and the CSI-RS 2 related to the terminal device 1 in the CSI-RS 1 to the CSI-RS 6. The terminal device 2 determines, based on port information of the CSI-RS 3 and the CSI-RS 4, the CSI-RS 3 and the CSI-RS 4 related to the terminal device 2 in the CSI-RS 1 to the CSI-RS 6. The terminal device 3 determines, based on port information of the CSI-RS 5 and the CSI-RS 6, the CSI-RS 5 and the CSI-RS 6 related to the terminal device 3 in the CSI-RS 1 to the CSI-RS 6. The terminal device 1 may determine, according to the method in the embodiment in FIG. 2, the port information of the CSI-RS 1 and the CSI-RS 2 related to the terminal device 1, the terminal device 2 may determine, according to the method in the embodiment in FIG. 2, the port information of the CSI-RS 3 and the CSI-RS 4 related to the terminal device 2, and the terminal device 3 may determine, according to the method in the embodiment in FIG. 2, the port information of the CSI-RS 5 and the CSI-RS 6 related to the terminal device 3.

The following describes a method for receiving a CSI-RS by a terminal device.

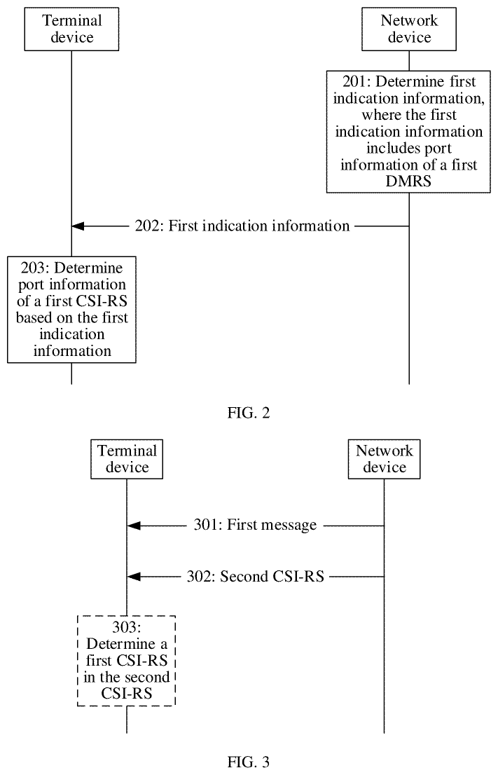

FIG. 3 is a schematic flowchart of a method for sending a CSI-RS according to an embodiment. The embodiment in FIG. 3 may be independently implemented, or may be implemented in combination with the embodiment in FIG. 2. The method includes the following steps or operations.

Step or operation 301: a network device sends a first message to a terminal device. Correspondingly, the terminal device receives the first message.

For example, the first message may be radio resource control (RRC) signaling, medium access control control element (MAC CE) signaling, or another type of message. This is not limited.

In a first embodiment, the first message includes one piece of CSI-RS configuration information, and the CSI-RS configuration information is for configuring one or more CSI-RSs of one or more terminal devices. For example, the first message includes configuration information of a third CSI-RS, the third CSI-RS includes a CSI-RS of one or more terminal devices, and the configuration information of the third CSI-RS includes at least one of the following: a port number of the third CSI-RS, a frequency domain density of the third CSI-RS, a CDM type corresponding to the third CSI-RS, or a time domain/frequency domain position of the third CSI-RS. The port number of the third CSI-RS is M, and M is a positive integer. For example, if the third CSI-RS includes a CSI-RS 1 to a CSI-RS 6, the port number of the third CSI-RS in the configuration information of the third CSI-RS is 6. It may be understood that the CSI-RS configuration information included in the first message is for configuring a CSI-RS with M ports.

In a second embodiment, the first message includes a plurality of pieces of CSI-RS configuration information, and each of the plurality of pieces of CSI-RS configuration information is for configuring a CSI-RS of one or more terminal devices. Different pieces of CSI-RS configuration information are for configuring CSI-RSs of different terminal device groups, where one terminal device group includes one or more terminal devices. For example, the first message indicates K pieces of configuration information, and K is an integer greater than 1. For example, the first message includes three pieces of CSI-RS configuration information, and the three pieces of CSI-RS configuration information include configuration information of a fourth CSI-RS, configuration information of a fifth CSI-RS, and configuration information of a sixth CSI-RS. The fourth CSI-RS includes a CSI-RS of one or more terminal devices, and the configuration information of the fourth CSI-RS includes at least one of the following: a port number of the fourth CSI-RS, a frequency domain density of the fourth CSI-RS, a CDM type corresponding to the fourth CSI-RS, or a time domain/frequency domain position of the fourth CSI-RS. The port number of the fourth CSI-RS is N, and N is a positive integer. For example, if the fourth CSI-RS includes a CSI-RS 1 to a CSI-RS 6, the port number of the fourth CSI-RS in the configuration information of the fourth CSI-RS is 6. The fifth CSI-RS includes a CSI-RS of one or more terminal devices, and the configuration information of the fifth CSI-RS includes at least one of the following: a port number of the fifth CSI-RS, a frequency domain density of the fifth CSI-RS, a CDM type corresponding to the fifth CSI-RS, or a time domain/frequency domain position of the fifth CSI-RS. The port number of the fifth CSI-RS is L. Lis a positive integer, and L may be the same as or different from N. For example, if the fifth CSI-RS includes a CSI-RS 1 to a CSI-RS 8, the port number of the CSI-RS in the configuration information of the fifth CSI-RS is 8. An embodiment of the configuration information of the sixth CSI-RS is similar to those of the configuration information of the fourth CSI-RS and the configuration information of the fifth CSI-RS. Details are not described again.

Step or operation 302: the network device sends a second CSI-RS to the terminal device. Correspondingly, the terminal device receives the second CSI-RS.

In the step or operation, the network device sends the second CSI-RS to the terminal device based on one or more pieces of CSI-RS configuration information included in the first message. The second CSI-RS is a CSI-RS sent by the network device, and the second CSI-RS may include a CSI-RS of one or more terminal devices.

For the first implementation in step or operation 301, the second CSI-RS may be the same as the foregoing third CSI-RS, or the second CSI-RS is a part of the third CSI-RS. For example, if the third CSI-RS includes a CSI-RS 1 to a CSI-RS 8 and the second CSI-RS includes the CSI-RS 1 to the CSI-RS 6, the second CSI-RS is a part of the third CSI-RS. Therefore, the port number of the third CSI-RS configured by the network device may be equal to or greater than the port number of the sent second CSI-RS.

For the second implementation in step or operation 301, when the network device sends the plurality of pieces of CSI-RS configuration information to the terminal device, the network device selects one of the plurality of pieces of CSI-RS configuration information. The following uses an example in which the configuration information of the fourth CSI-RS is selected. The second CSI-RS sent by the network device may be the same as the fourth CSI-RS, or the second CSI-RS is a part of the fourth CSI-RS. For example, if the fourth CSI-RS includes a CSI-RS 1 to a CSI-RS 10 and the second CSI-RS includes the CSI-RS 1 to the CSI-RS 6, the second CSI-RS is a part of the fourth CSI-RS. Therefore, the configured port number of the fourth CSI-RS configured by the network device may be equal to or greater than the port number of the sent second CSI-RS. The terminal device may determine, in any one of the following manners, the configuration information of the fourth CSI-RS selected by the network device.

Manner 1: the network device sends third indication information to the terminal device, where the third indication information includes the configuration information of the fourth CSI-RS in the plurality of pieces of CSI-RS configuration information.

For example, the third indication information is included in DCI.

Manner 2: the terminal device determines the configuration information of the fourth CSI-RS in the plurality of pieces of CSI-RS configuration information.

For example, the terminal device determines the configuration information of the fourth CSI-RS in the plurality of pieces of CSI-RS configuration information based on DMRS configuration information. In other words, the configuration information of the fourth CSI-RS is associated with (or corresponds to) the DMRS configuration information. The DMRS configuration information includes at least one of the following information: a DMRS type (DMRS type), a maximum number of DMRS symbols (Max-length), a number of front-loaded DMRS symbols (Number of front-loaded symbols), or a number of DMRS CDM groups (Number of DMRS CDM group(s) without data).

The DMRS configuration information may come from the network device. For example, the network device sends fourth indication information to the terminal device. The fourth indication information includes the DMRS configuration information, the fourth indication information and the first indication information in the embodiment in FIG. 2 jointly indicate the DMRS configuration information, or the first indication information in the embodiment in FIG. 2 further includes the DMRS configuration information. Alternatively, the terminal device determines the DMRS configuration information.

For example, a combination relationship between the DMRS type, the maximum number of DMRS symbols, the number of front-loaded DMRS symbols, and the number of DMRS CDM groups is shown in Table 1. A correspondence between each combination and CSI-RS configuration information may be predefined, and one combination corresponds to one DMRS configuration. For example, when the DMRS type is a type 1, the maximum number of DMRS symbols is equal to 2, the number of front-loaded DMRS symbols is equal to 1, and the number of DMRS CDM groups is equal to 1, the selected CSI-RS configuration information is the configuration information of the fourth CSI-RS in the plurality of pieces of CSI-RS configuration information. When the DMRS type is the type 1, the maximum number of DMRS symbols is equal to 2, the number of front-loaded DMRS symbols is equal to 1, and the number of DMRS CDM groups is equal to 2, the selected CSI-RS configuration information is the configuration information of the fifth CSI-RS in the plurality of pieces of CSI-RS configuration information. The rest may be deduced by analogy. Different combinations may correspond to a same piece of CSI-RS configuration information, or may correspond to different pieces of CSI-RS configuration information.

TABLE 1

| | | Number of | |
|---|---|---|---|
| DMRS | Maximum number | front-loaded | Number of DMRS |
| type | of DMRS symbols | DMRS symbols | CDM groups |
| Type 1 | 2 | 1 | 1 |
| Type 1 | 2 | 1 | 2 |
| Type 1 | 2 | 2 | 1 |
| Type 1 | 2 | 2 | 2 |
| Type 2 | 2 | 1 | 1 |
| Type 2 | 2 | 1 | 2 |
| Type 2 | 2 | 1 | 3 |
| Type 2 | 2 | 2 | 1 |
| Type 2 | 2 | 2 | 2 |
| Type 2 | 2 | 2 | 3 |
| Type 1 | 1 | / | 1 |
| Type 1 | 1 | / | 2 |
| Type 2 | 1 | / | 1 |
| Type 2 | 1 | / | 2 |
| Type 2 | 1 | / | 3 |
| Enhanced | 2 | 1 | 1 |
| type 1 | | | |
| Enhanced | 2 | 1 | 2 |
| type 1 | | | |
| Enhanced | 2 | 2 | 1 |
| type 1 | | | |
| Enhanced | 2 | 2 | 2 |
| type 1 | | | |
| Enhanced | 2 | 1 | 1 |
| type 2 | | | |
| Enhanced | 2 | 1 | 2 |
| type 2 | | | |
| Enhanced | 2 | 1 | 3 |
| type 2 | | | |
| Enhanced | 2 | 2 | 1 |
| type 2 | | | |
| Enhanced | 2 | 2 | 2 |
| type 2 | | | |
| Enhanced | 2 | 2 | 3 |
| type 2 | | | |
| Enhanced | 1 | / | 1 |
| type 1 | | | |
| Enhanced | 1 | / | 2 |
| type 1 | | | |
| Enhanced | 1 | / | 1 |
| type 2 | | | |
| Enhanced | 1 | / | 2 |
| type 2 | | | |
| Enhanced | 1 | / | 3 |
| type 2 | | | |

For example, the terminal device may also determine a maximum number of DMRS ports based on the DMRS configuration information. The maximum number of DMRS ports may be a maximum number of simultaneously scheduled DMRS ports. Then, the terminal device determines a piece of CSI-RS configuration information in the plurality of pieces of CSI-RS configuration information based on the maximum number of DMRS ports, for example, determines the configuration information of the fourth CSI-RS in the plurality of pieces of CSI-RS configuration information. For example, a combination relationship between the DMRS type, the maximum number of DMRS symbols, the number of front-loaded DMRS symbols, the number of DMRS CDM groups, and the maximum number of DMRS ports is shown in Table 2.

TABLE 2

| | Maximum | Number of | Number | Maximum |
|---|---|---|---|---|
| | number of | front-loaded | of DMRS | number of |
| DMRS | DMRS | DMRS | CDM | DMRS |
| type | symbols | symbols | groups | ports |
| Type 1 | 2 | 1 | 1 | 2 |
| Type 1 | 2 | 1 | 2 | 4 |
| Type 1 | 2 | 2 | 1 | 4 |
| Type 1 | 2 | 2 | 2 | 8 |
| Type 2 | 2 | 1 | 1 | 2 |
| Type 2 | 2 | 1 | 2 | 4 |
| Type 2 | 2 | 1 | 3 | 6 |
| Type 2 | 2 | 2 | 1 | 4 |
| Type 2 | 2 | 2 | 2 | 8 |
| Type 2 | 2 | 2 | 3 | 12 |
| Type 1 | 1 | / | 1 | 2 |
| Type 1 | 1 | / | 2 | 4 |
| Type 2 | 1 | / | 1 | 2 |
| Type 2 | 1 | / | 2 | 4 |
| Type 2 | 1 | / | 3 | 6 |
| Enhanced | 2 | 1 | 1 | 4 |
| type 1 | | | | |
| Enhanced | 2 | 1 | 2 | 8 |
| type 1 | | | | |
| Enhanced | 2 | 2 | 1 | 8 |
| type 1 | | | | |
| Enhanced | 2 | 2 | 2 | 16 |
| type 1 | | | | |
| Enhanced | 2 | 1 | 1 | 4 |
| type 2 | | | | |
| Enhanced | 2 | 1 | 2 | 8 |
| type 2 | | | | |
| Enhanced | 2 | 1 | 3 | 12 |
| type 2 | | | | |
| Enhanced | 2 | 2 | 1 | 8 |
| type 2 | | | | |
| Enhanced | 2 | 2 | 2 | 16 |
| type 2 | | | | |
| Enhanced | 2 | 2 | 3 | 24 |
| type 2 | | | | |
| Enhanced | 1 | / | 1 | 4 |
| type 1 | | | | |
| Enhanced | 1 | / | 2 | 8 |
| type 1 | | | | |
| Enhanced | 1 | / | 1 | 4 |
| type 2 | | | | |
| Enhanced | 1 | / | 2 | 8 |
| type 2 | | | | |
| Enhanced | 1 | / | 3 | 12 |
| type 2 | | | | |

It may be understood from Table 2 that, a correspondence between the DMRS configuration information and the maximum number of DMRS ports may be: when the maximum number of DMRS symbols is equal to 1, Maximum number of DMRS ports=a*Number of DMRS CDM groups; or when the maximum number of DMRS symbols is equal to 2, the maximum number of DMRS ports=a*Number of DMRS CDM groups*Number of front-loaded DMRS symbols. * represents a multiplication sign, a is related to the DMRS type, and a represents a number of DMRS ports of one CDM group and one symbol. Using Table 2 as an example, when the DMRS type is the type 1 (Type 1) or the type 2 (Type 2), a=2; or when the DMRS type is the enhanced type 1 (enhanced Type 1) or the enhanced type 2 (enhanced Type 2), a=4.

Then, a terminal determines the configuration information of the fourth CSI-RS in the plurality of pieces of CSI-RS configuration information based on the maximum number of DMRS ports. A relationship between the configuration information of the fourth CSI-RS that is selected by the terminal device and that is in the plurality of pieces of CSI-RS configuration information and the maximum number of DMRS ports is: the port number of the fourth CSI-RS is a smallest value in a CSI-RS port number set, each CSI-RS port number in the CSI-RS port number set is included in numbers of CSI-RS ports indicated by all of the plurality of pieces of CSI-RS configuration information, and each CSI-RS port number in the CSI-RS port number set is greater than or equal to the maximum number of DMRS ports. For example, the plurality of pieces of CSI-RS configuration information include CSI-RS configuration information 1 to CSI-RS configuration information 4, where a number of CSI-RS ports in the CSI-RS configuration information 1 is 12, a number of CSI-RS ports in the CSI-RS configuration information 2 is 16, a number of CSI-RS ports in the CSI-RS configuration information 3 is 24, and a number of CSI-RS ports in the CSI-RS configuration information 4 is 32. For example, when the maximum number of DMRS ports is 12, the CSI-RS configuration information 1 is selected, and the CSI-RS configuration information 1 is also referred to as the configuration information of the fourth CSI-RS. In this case, the CSI-RS port number set is {12, 16, 24, 32}. For another example, when the maximum number of DMRS ports is 16, the CSI-RS configuration information 2 is selected, and the CSI-RS configuration information 2 is also referred to as the configuration information of the fourth CSI-RS. In this case, the CSI-RS port number set is {16, 24, 32}. For another example, when the maximum number of DMRS ports is 24, the CSI-RS configuration information 3 is selected, and the CSI-RS configuration information 3 is also referred to as the configuration information of the fourth CSI-RS. In this case, the CSI-RS port number set is {24, 32}.

In an implementation, after step or operation 302, the method further includes the following step or operation 303.

Step or operation 303: the terminal device determines a first CSI-RS in the second CSI-RS.

Step or operation 303 is an optional step or operation.

The first CSI-RS determined by the terminal device is a CSI-RS that is in the second CSI-RS and that is related to the terminal device. For example, the terminal device first determines port information of the first CSI-RS related to the terminal device, and then determines the first CSI-RS related to the terminal device in the second CSI-RS based on the port information of the first CSI-RS. The terminal device may determine the port information of the first CSI-RS related to the terminal device by using the method in the embodiment in FIG. 2, or may determine the port information of the first CSI-RS related to the terminal device by using another method. For example, the network device indicates, to the terminal device, the port information of the first CSI-RS related to the terminal device by using DCI.

Further, after determining the port information of the first CSI-RS related to the terminal device, the terminal device may determine uplink precoding based on the port information of the first CSI-RS. The following describes an implementation of determining the uplink precoding.

Step or operation 1: the terminal device sends a sounding reference signal (SRS) to the network device.

Step or operation 2: the network device estimates an uplink channel H_{UL} based on the SRS, and obtains a downlink channel H_{DL} based on reciprocity between uplink and downlink.

For example, the network device may estimate the uplink channel H_{UL} of the terminal device based on the SRS from the terminal device.

For example, the network device may alternatively estimate an uplink channel of one or more other terminal devices based on an SRS from the one or more other terminal devices.

Step or operation 3: the network device calculates uplink precoding P_{UL} of the terminal device based on the uplink channel H_{UL} of the terminal, or based on the uplink channel H_{UL} of the terminal and a jointly scheduled uplink channel of another terminal.

Step or operation 4: the network device determines downlink precoding P_{DL}, so that a downlink equivalent channel H_{equ_DL} is equal to the uplink precoding P_{UL}, for example,

$${H}_{equ \_ DL} = {P}_{UL} = {H}_{DL} * {P}_{DL} .$$

$${P}_{DL} = {H}_{DL}^{- 1} * {P}_{UL} .$$

Step or operation 5: the network device performs precoding on a CSI-RS based on P_{DL}, to obtain a beamforming CSI-RS (BF CSI-RS).

If S_{BF-CSI-RS} is used to represent a signal of the BF CSI-RS, S_{BF-CSI-RS}=P_{DL}*S_{CSI-RS}.

Step or operation 6: the network device sends the BF CSI-RS to the terminal device, and the terminal device receives a first signal Y.

Y=H_{DL}*P_{DL}*S_{CSI-RS}+n=H_{equ_DL}*S_{CSI-RS}+n. n is received noise.

Step or operation 7: the terminal device determines S_{CSI-RS} based on CSI-RS port information related to the terminal device, and estimates the equivalent channel H_{equ_DL} based on S_{CSI-RS} and the received signal Y.

The terminal device may determine the CSI-RS port information related to the terminal device according to the method in the embodiment in FIG. 2.

Step or operation 8: the terminal device determines the uplink precoding P_{UL}, for example, P_{UL}=H_{equ_DL}, based on H_{equ_DL}.

The foregoing solution is a high-precision precoding indication solution for an uplink subband or wideband based on a BF CSI-RS, and can improve accuracy of uplink precoding. In addition, because the CSI-RS port information is indicated to the terminal device without using DCI, but the terminal device determines the CSI-RS port information based on DMRS port information, signaling overheads can be reduced.

It should be noted that there may alternatively be another solution for the high-precision precoding indication solution for the uplink sub-band based on the BF CSI-RS. For example, a base station sends the BF CSI-RS, where a transmitted precoding matrix indicator (TPMI) in DCI indicates codebook-based uplink precoding information; and the terminal device calculates the uplink precoding based on the BF CSI-RS and the TPMI in the DCI.

It may be understood that, to implement the functions in the foregoing embodiments, the terminal device or the network device includes corresponding hardware structures and/or software modules for performing the functions. A person skilled in the art should be easily aware that, in the embodiments, the units and method steps or operations in the examples described with reference to embodiments can be implemented by hardware or a combination of hardware and computer software. Whether a function is performed by hardware or hardware driven by computer software depends on particular application scenarios and design constraints of the solutions.

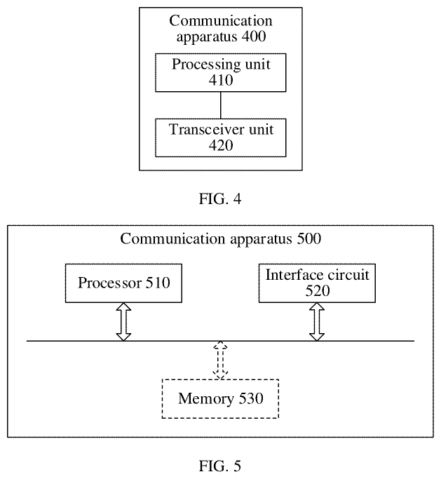

FIG. 4 and FIG. 5 each is a diagram of a possible structure of a communication apparatus according to an embodiment. The communication apparatuses may be configured to implement a function of the terminal device or the network device in the foregoing method embodiments. Therefore, at least beneficial effects of the foregoing method embodiments can also be implemented. In embodiments, the communication apparatus may be the terminal device or the network device, or may be a module (for example, a chip) used in the terminal device or the network device.

A communication apparatus 400 shown in FIG. 4 includes a processing unit 410 and a transceiver unit 420. The communication apparatus 400 is configured to implement the function of the terminal device or the network device in the foregoing method embodiments.

When the communication apparatus 400 is configured to implement the function of the terminal device in the foregoing method embodiments, the transceiver unit 420 is configured to receive first indication information, where the first indication information includes port information of a first DMRS; and the processing unit 410 is configured to determine the port information of the first CSI-RS based on the first indication information.

In a possible embodiment, the first indication information includes a port index of the first DMRS, and the port information of the first CSI-RS includes a port index of the first CSI-RS.

In a possible embodiment, the port index of the first CSI-RS is the same as the port index of the first DMRS.

In a possible embodiment, that the processing unit 410 is configured to determine the port information of the first CSI-RS based on the first indication information may include: determining the port information of the first CSI-RS corresponding to the first indication information based on the first indication information and a first mapping relationship predefined in a protocol, where the first mapping relationship includes a mapping relationship between DMRS port information and CSI-RS port information.

In a possible embodiment, the transceiver unit 420 is further configured to receive second indication information, where the second indication information includes a second mapping relationship between the first indication information and the port information of the first CSI-RS; and that the processing unit 410 is configured to determine the port information of the first CSI-RS based on the first indication information may include: determining the port information of the first CSI-RS based on the first indication information and the second mapping relationship.

In a possible embodiment, the transceiver unit 420 is further configured to receive a second CSI-RS; and the processing unit 410 is further configured to determine the first CSI-RS in the second CSI-RS based on the first indication information.

In a possible embodiment, the transceiver unit 420 is further configured to receive a first message, where the first message includes configuration information of a third CSI-RS, and the second CSI-RS is a part of the third CSI-RS.

In a possible embodiment, the transceiver unit 420 is further configured to receive a first message, where the first message includes a plurality of pieces of configuration information; and that the transceiver unit 420 is configured to receive the second CSI-RS may include: receiving the second CSI-RS based on configuration information of a fourth CSI-RS in the plurality of pieces of configuration information, where the second CSI-RS is a part of the fourth CSI-RS.

In a possible embodiment, the transceiver unit 420 is further configured to receive third indication information, where the third indication information includes the configuration information of the fourth CSI-RS in the plurality of pieces of CSI-RS configuration information.

In a possible embodiment, the processing unit 410 is further configured to determine the configuration information of the fourth CSI-RS based on DMRS configuration information, where the configuration information of the fourth CSI-RS is associated with the DMRS configuration information, and the DMRS configuration information includes at least one of the following information: a DMRS type, a maximum number of DMRS symbols, a number of front-loaded DMRS symbols, or a number of DMRS CDM groups.

In a possible embodiment, that the processing unit 410 is configured to determine the configuration information of the fourth CSI-RS based on the DMRS configuration information may include: determining a maximum number of DMRS ports based on the DMRS configuration information; and determining the configuration information of the fourth CSI-RS based on the maximum number of DMRS ports, where a port number of the fourth CSI-RS is a smallest value in a CSI-RS port number set, each CSI-RS port number in the CSI-RS port number set is included in numbers of CSI-RS ports indicated by all of the plurality of pieces of CSI-RS configuration information, and each CSI-RS port number in the CSI-RS port number set is greater than or equal to the maximum number of DMRS ports.

In a possible embodiment, the maximum number of DMRS symbols is equal to 1, and the maximum number of DMRS ports is equal to a product of a and the number of DMRS CDM groups; or the maximum number of DMRS symbols is equal to 2, and the maximum number of DMRS ports is equal to a product of a, the number of DMRS CDM groups, and the number of front-loaded DMRS symbols, where a is related to the DMRS type.

In a possible embodiment, the DMRS type is a type 1 or a type 2, and a is equal to 2; or the DMRS type is an enhanced type 1 or an enhanced type 2, and a is equal to 4.

In a possible embodiment, the transceiver unit 420 is further configured to receive fourth indication information, where the fourth indication information includes the DMRS configuration information, or the first indication information and the fourth indication information indicate the DMRS configuration information.

In a possible embodiment, the plurality of pieces of CSI-RS configuration information further include configuration information of a fifth CSI-RS, and a port number of the fifth CSI-RS is different from the port number of the fourth CSI-RS.

In a possible embodiment, the processing unit 410 is further configured to determine uplink precoding based on the port information of the first CSI-RS.

When the communication apparatus 400 is configured to implement the function of the terminal device in the foregoing method embodiments, the transceiver unit 420 is configured to receive a first message, where the first message includes configuration information of a third CSI-RS; and receive a second CSI-RS, where the second CSI-RS is a part of the third CSI-RS.

When the communication apparatus 400 is configured to implement the function of the terminal device in the foregoing method embodiments, the transceiver unit 420 is configured to receive a first message, where the first message includes a plurality of pieces of CSI-RS configuration information; and receive a second CSI-RS based on configuration information of a fourth CSI-RS in the plurality of pieces of CSI-RS configuration information, where the second CSI-RS is a part of the fourth CSI-RS.

In a possible embodiment, the transceiver unit 420 is further configured to receive third indication information, where the third indication information includes the configuration information of the fourth CSI-RS in the plurality of pieces of CSI-RS configuration information.

In a possible embodiment, the transceiver unit 420 is further configured to receive fourth indication information, where the fourth indication information includes DMRS configuration information, or the fourth indication information and the first indication information indicate the DMRS configuration information; the DMRS configuration information is associated with the configuration information of the fourth CSI-RS; and the DMRS configuration information includes at least one of the following information: a DMRS type, a maximum number of DMRS symbols, a number of front-loaded DMRS symbols, or a number of DMRS CDM groups.

When the communication apparatus 400 is configured to implement the function of the network device in the foregoing method embodiments, the processing unit 410 is configured to determine first indication information, where the first indication information includes port information of a first DMRS, and the port information of the first DMRS is for determining port information of a first CSI-RS; and the transceiver unit 420 is configured to send the first indication information.

In a possible embodiment, the first indication information includes a port index of the first DMRS, and the port information of the first CSI-RS includes a port index of the first CSI-RS.

In a possible embodiment, the port index of the first CSI-RS is the same as the port index of the first DMRS.

In a possible embodiment, a first mapping relationship between DMRS port information and CSI-RS port information is predefined in a protocol.

In a possible embodiment, the transceiver unit 420 is further configured to send second indication information, where the second indication information includes a second mapping relationship between the first indication information and the port information of the first CSI-RS.

In a possible embodiment, the transceiver unit 420 is further configured to send a first message, where the first message includes configuration information of a third CSI-RS; and send a second CSI-RS, where the second CSI-RS is a part of the third CSI-RS, and the second CSI-RS includes the first CSI-RS.

In a possible embodiment, the transceiver unit 420 is further configured to send a first message, where the first message includes a plurality of pieces of CSI-RS configuration information; send third indication information, where the third indication information includes configuration information of a fourth CSI-RS in the plurality of pieces of CSI-RS configuration information; and send a second CSI-RS, where the second CSI-RS is a part of the fourth CSI-RS.

In a possible embodiment, the transceiver unit 420 is further configured to send a first message, where the first message includes a plurality of pieces of CSI-RS configuration information; send fourth indication information, where the fourth indication information includes DMRS configuration information, or the first indication information and the fourth indication information indicate the DMRS configuration information; the DMRS configuration information is associated with configuration information of a fourth CSI-RS in the plurality of pieces of CSI-RS configuration information; and the DMRS configuration information includes at least one of the following information: a DMRS type, a maximum number of DMRS symbols, a number of front-loaded DMRS symbols, or a number of DMRS CDM groups; and send a second CSI-RS, where the second CSI-RS is a part of the fourth CSI-RS.

In a possible embodiment, a port number of the fourth CSI-RS is a smallest value in a CSI-RS port number set, each CSI-RS port number in the CSI-RS port number set is included in numbers of CSI-RS ports indicated by all of the plurality of pieces of CSI-RS configuration information, each CSI-RS port number in the CSI-RS port number set is greater than or equal to a maximum number of DMRS ports, and the maximum number of DMRS ports is associated with the DMRS configuration information.

In a possible embodiment, the maximum number of DMRS symbols is equal to 1, and the maximum number of DMRS ports is equal to a product of a and the number of DMRS CDM groups; or the maximum number of DMRS symbols is equal to 2, and the maximum number of DMRS ports is equal to a product of a, the number of DMRS CDM groups, and the number of front-loaded DMRS symbols, where a is related to the DMRS type.

In a possible embodiment, the DMRS type is a type 1 or a type 2, and a is equal to 2; or the DMRS type is an enhanced type 1 or an enhanced type 2, and a is equal to 4.

In a possible embodiment, the plurality of pieces of CSI-RS configuration information further include configuration information of a fifth CSI-RS, and a port number of the fifth CSI-RS is different from the port number of the fourth CSI-RS.

When the communication apparatus 400 is configured to implement the function of the network device in the foregoing method embodiments, the transceiver unit 420 is configured to send a first message, where the first message includes configuration information of a third CSI-RS; and send a second CSI-RS, where the second CSI-RS is a part of the third CSI-RS.

When the communication apparatus 400 is configured to implement the function of the network device in the foregoing method embodiments, the transceiver unit 420 is configured to send a first message, where the first message includes a plurality of pieces of CSI-RS configuration information; send third indication information, where the third indication information includes configuration information of a fourth CSI-RS in the plurality of pieces of CSI-RS configuration information; and send a second CSI-RS, where the second CSI-RS is a part of the fourth CSI-RS.

When the communication apparatus 400 is configured to implement the function of the network device in the foregoing method embodiments, the transceiver unit 420 is configured to send a first message, where the first message includes a plurality of pieces of CSI-RS configuration information; send fourth indication information, where the fourth indication information includes DMRS configuration information, the DMRS configuration information is associated with configuration information of a fourth CSI-RS in the plurality of pieces of CSI-RS configuration information, and the DMRS configuration information includes at least one of the following information: a DMRS type, a maximum number of DMRS symbols, a number of front-loaded DMRS symbols, or a number of DMRS CDM groups; and send a second CSI-RS, where the second CSI-RS is a part of the fourth CSI-RS.

For more detailed descriptions about the foregoing processing unit 410 and transceiver unit 420, directly refer to the related descriptions in the foregoing method embodiments. Details are not described herein again.

A communication apparatus 500 shown in FIG. 5 includes a processor 510 and an interface circuit 520. The processor 510 and the interface circuit 520 are coupled to each other. It may be understood that the interface circuit 520 may be a transceiver or an input/output interface. Optionally, the communication apparatus 500 may further include a memory 530 configured to store instructions to be executed by the processor 510, store input data required by the processor 510 to run the instructions, or store data generated after the processor 510 runs the instructions.

When the communication apparatus 500 is configured to implement the foregoing method embodiments, the processor 510 is configured to implement a function of the foregoing processing unit 410, and the interface circuit 520 is configured to implement a function of the foregoing transceiver unit 420.

It may be understood that the processor in embodiments may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any regular processor or the like.

The method steps or operations in embodiments may be implemented in a hardware manner, or may be implemented in a manner of executing software instructions by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, and a compact disc read-only memory (CD-ROM) or any other form of storage medium well known in the art. For example, a storage medium is coupled to the processor, so that the processor can read information from the storage medium and write information into the storage medium. In another embodiment, the storage medium may be a component of the processor. The processor and the storage medium may be disposed in an ASIC. In addition, the ASIC may be located in the terminal device or the network device. In another embodiment, the processor and the storage medium may also exist in an access network device or a terminal as discrete components.

All or a part of the foregoing embodiments may be implemented by using software, hardware, firmware, or any combination thereof. When software is used to implement embodiments, all or a part of embodiments may be implemented in a form of a computer program product. The computer program product includes one or more computer programs or instructions. The computer program is a set of instructions that indicate each step or operation of an electronic computer or another device having a message processing capability, may be written in a program design language, and is run in a target system structure. When the computer programs or instructions are loaded and executed on a computer, procedures or functions in embodiments are all or partially executed. The computer may be a general-purpose computer, a dedicated computer, a computer network, or another programmable apparatus. The computer program or instructions may be stored in a non-transitory computer-readable storage medium, or may be transmitted from a non-transitory computer-readable storage medium to another non-transitory computer-readable storage medium. For example, the computer program or instructions may be transmitted from a website, computer, server, or data center to another website, computer, server, or data center in a wired or wireless manner. The non-transitory computer-readable storage medium may be any usable medium that can be accessed by the computer, or a data storage device, for example, a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The non-transitory computer-readable storage medium may be a volatile or nonvolatile storage medium, or may include two types of storage media: a volatile storage medium and a nonvolatile storage medium.

In various embodiments, unless otherwise stated or if there is a logic conflict, terms and/or descriptions in different embodiments are consistent and may be mutually referenced, and features in different embodiments may be combined into a new embodiment based on an internal logical relationship thereof.

In the embodiments, “at least one” means one or more, and “plurality of” means two or more. “And/or” describes an association relationship between associated objects, and indicates that three relationships may exist. For example, A and/or B may indicate the following three cases: only A exists, both A and B exist, and only B exists, where A and B may be in a singular form or a plural form. In the embodiments, the character “/” represents an “or” relationship between the associated objects. In a formula in the embodiments, the character “/” represents a “division” relationship between the associated objects.

It may be understood that various numbers in embodiments are for differentiation for ease of description, and are not used to limit the scope of embodiments. Sequence numbers of the foregoing processes do not mean an execution sequence, and the execution sequence of the processes may be determined based on functions and internal logic of the processes.

The foregoing descriptions are merely optional embodiments, and are not intended as limiting. Any modification, equivalent replacement, or improvement made without departing from the spirit and principle of the embodiments should fall within their scope.

1. A method for indicating a reference signal, comprising:
receiving first indication information, wherein the first indication information comprises port information of a first demodulation reference signal (DMRS); and
determining port information of a first channel state information reference signal (CSI-RS) based on the first indication information.

2. The method according to claim 1, wherein the first indication information comprises a port index of the first DMRS, and the port information of the first CSI-RS comprises a port index of the first CSI-RS.

3. The method according to claim 2, wherein the port index of the first CSI-RS is the same as the port index of the first DMRS.

4. The method according to claim 1, wherein determining the port information of the first CSI-RS based on the first indication information comprises:
determining the port information of the first CSI-RS based on the first indication information and a first mapping relationship predefined in a protocol, wherein
the first mapping relationship comprises a mapping relationship between DMRS port information and CSI-RS port information, the DMRS port information comprises the port information of the first DMRS, and the CSI-RS port information comprises the port information of the first CSI-RS.

5. The method according to claim 1, further comprising:
receiving second indication information, wherein the second indication information comprises a second mapping relationship between the first indication information and the port information of the first CSI-RS;
wherein determining the port information of the first CSI-RS based on the first indication information comprises:
determining the port information of the first CSI-RS based on the first indication information and the second mapping relationship.

6. The method according to claim 1, further comprising:
receiving a second CSI-RS; and
determining the first CSI-RS in the second CSI-RS based on the first indication information.

7. The method according to claim 6, further comprising:
receiving a first message, wherein the first message comprises configuration information of a third CSI-RS, and the second CSI-RS is a part of the third CSI-RS.

8. The method according to claim 6, further comprising:
receiving a first message, wherein the first message comprises a plurality of pieces of CSI-RS configuration information;
wherein receiving the second CSI-RS comprises:
receiving the second CSI-RS based on configuration information of a fourth CSI-RS in the plurality of pieces of CSI-RS configuration information, wherein
the second CSI-RS is a part of the fourth CSI-RS.

9. A method for indicating a reference signal, comprising:
determining first indication information, wherein the first indication information comprises port information of a first demodulation reference signal (DMRS), and the port information of the first DMRS is for determining port information of a first channel state information reference signal (CSI-RS); and
sending the first indication information.

10. The method according to claim 9, wherein the first indication information comprises a port index of the first DMRS, and the port information of the first CSI-RS comprises a port index of the first CSI-RS.

11. The method according to claim 10, wherein the port index of the first CSI-RS is the same as the port index of the first DMRS.

12. The method according to claim 9, wherein a first mapping relationship between DMRS port information and CSI-RS port information is predefined in a protocol, wherein the DMRS port information comprises the port information of the first DMRS, and the CSI-RS port information comprises the port information of the first CSI-RS.

13. The method according to claim 9, further comprising:
sending second indication information, wherein the second indication information comprises a second mapping relationship between the first indication information and the port information of the first CSI-RS.

14. The method according to claim 9, further comprising:
sending a first message, wherein the first message comprises configuration information of a third CSI-RS; and
sending a second CSI-RS, wherein the second CSI-RS is a part of the third CSI-RS, and the second CSI-RS comprises the first CSI-RS.

15. The method according to claim 9, further comprising:
sending a first message, wherein the first message comprises a plurality of pieces of CSI-RS configuration information;
sending third indication information, wherein the third indication information comprises configuration information of a fourth CSI-RS in the plurality of pieces of CSI-RS configuration information; and
sending a second CSI-RS, wherein the second CSI-RS is a part of the fourth CSI-RS.

16. The method according to claim 9, further comprising:
sending a first message, wherein the first message comprises a plurality of pieces of CSI-RS configuration information;
sending fourth indication information, wherein the fourth indication information comprises DMRS configuration information, or the fourth indication information and the first indication information indicate the DMRS configuration information; the DMRS configuration information is associated with configuration information of a fourth CSI-RS in the plurality of pieces of CSI-RS configuration information; and the DMRS configuration information comprises at least one of: a DMRS type, a maximum number of DMRS symbols, a number of front-loaded DMRS symbols, or a number of DMRS CDM groups; and
sending a second CSI-RS, wherein the second CSI-RS is a part of the fourth CSI-RS.

17. A communication apparatus, comprising: at least one processor configured to execute programming instructions to enable the communication apparatus to implement operations comprising:
receiving first indication information, wherein the first indication information comprises port information of a first demodulation reference signal (DMRS); and
determining port information of a first channel state information reference signal (CSI-RS) based on the first indication information.

18. The communication apparatus according to claim 17, wherein the first indication information comprises a port index of the first DMRS, and the port information of the first CSI-RS comprises a port index of the first CSI-RS.

19. The communication apparatus according to claim 18, wherein the port index of the first CSI-RS is the same as the port index of the first DMRS.

20. The communication apparatus according to claim 17, wherein determining the port information of the first CSI-RS based on the first indication information comprises:
determining the port information of the first CSI-RS based on the first indication information and a first mapping relationship predefined in a protocol, wherein
the first mapping relationship comprises a mapping relationship between DMRS port information and CSI-RS port information, the DMRS port information comprises the port information of the first DMRS, and the CSI-RS port information comprises the port information of the first CSI-RS.
